(19) United States
(12) Patent Application Publication
(10) Pub. No.: US 2014/0309467 A1
(43) Pub. Date: Oct. 16, 2014

(54) OPTIMIZED CATALYST FOR BIOMASS PYROLYSIS

(71) Applicant: BIOeCON International Holding N.V., Curacao (NL)

(72) Inventor: Paul O'CONNOR, HOEVELAKEN (NL)

(21) Appl. No.: 14/316,836

(22) Filed: Jun. 27, 2014

Related U.S. Application Data
(63) Continuation of application No. PCT/EP2012/076422, filed on Dec. 20, 2012.
(60) Provisional application No. 61/580,678, filed on Dec. 28, 2011.

(51) Int. Cl. B01J 27/232; C10G 1/00

(52) U.S. Cl. CPC B01J 27/232; C10G 1/00
USPC 585/16; 585/240; 502/174; 502/180; 502/80; 502/87

(57) ABSTRACT

An optimized catalyst system is disclosed for the pyrolysis of solid biomass material. The catalyst system is also suitable in upgrading reactions for biocrude. The system includes a carbonate species on a substantially inert support. The carbonate species can be an inorganic carbonate and/or an inorganic hydrogencarbonate.

### CROSS REFERENCE TO RELATED APPLICATIONS

This application is a continuation of PCT application number PCT/EP2012/076422 filed on 20 Dec. 2012, which claims priority from U.S. application No. 61/580,678 filed on 28 Dec. 2011. Both applications are hereby incorporated by reference in their entireties.

### BACKGROUND OF THE INVENTION

1. Field of the Invention

The invention relates generally to a catalyst for use in a catalytic process for converting biomass to liquid products, and more particularly to such a catalyst for the catalytic pyrolysis of lignocellulosic biomass.

2. Description of the Related Art

There is an urgent need to find processes for converting solid biomass materials to liquid fuels as a way to reduce mankind's dependence on mineral oil, to increase the use of renewable energy sources, and to reduce the build-up of carbon dioxide in the Earth's atmosphere.

Pyrolysis processes, in particular flash pyrolysis processes, are generally recognized as offering the most promising routes to the conversion of solid biomass materials to liquid products, generally referred to as bio-oil or bio-crude. In addition to liquid reaction products, these processes produce gaseous reaction products and solid reaction products. Gaseous reaction products comprise carbon dioxide, carbon monoxide, and relatively minor amounts of hydrogen, methane, and ethylene.

The solid reaction products comprise coke and char.

In order to maximize the liquid yield, while minimizing the solid and gaseous reaction products, the pyrolysis process should provide a fast heating rate of the biomass feedstock, a short residence time in the reactor, and rapid cooling of the reaction products. Lately the focus has been on ablative reactors, cyclone reactors, and fluidized reactors to provide the fast heating rates. Fluidized reactors include both fluidized stationary bed reactors and transport reactors.

Transport reactors provide heat to the reactor feed by injecting hot particulate heat carrier material into the reaction zone. This technique provides rapid heating of the feedstock. The fluidization of the feedstock ensures an even heat distribution within the mixing zone of the reactor.

U.S. Pat. No. 5,961,786 discloses a process for converting wood particles to a liquid smoke flavoring product. The process uses a transport reactor, with the heat being supplied by hot heat transfer particles. The document mentions sand, sand/catalyst mixtures, and silica-alumina catalysts as potential heat transfer materials. All examples are based on sand as the heat carrier, with comparative examples using char. The document reports relatively high liquid yields in the range of 50 to 65%. The liquid reaction products had a low pH (around 3) and high oxygen content. The liquid reaction products would require extensive upgrading for use as a liquid fuel, such as a gasoline replacement.

WO 2007/128799 A1 discloses a process for the pyrolysis of biomass wherein solid biomass is commingled with a particulate inorganic material, prior to the pyrolysis reaction. Examples of inorganic particulate materials include Na₂CO₃ and K₂CO₃. Ensuring intimate contact of the solid biomass material with catalytically active particles prior to the pyrolysis reaction enhances the catalytic activity during the relatively brief exposure of the solid biomass material to pyrolysis temperatures.

WO 2009/118363 A2 discloses a process for the catalytic pyrolysis of solid biomass materials. The solid biomass material is pretreated with a first catalyst, and converted in a transported bed in the presence of a second catalyst. The process produces liquid reaction products having low oxygen content, as evidenced by low Total Acid Number (TAN) readings. The presence of two catalysts in the reactor increases the risk of over-cracking the biomass feedstock and/or the primary reaction products. The use of two catalysts in different stages of the process requires a complex catalyst recovery system.

WO 2010/124069 A2 discloses a pyrolysis process in which a catalyst is used that is an oxide, silicate or carbonate of a metal or metalloid, having a specific surface area in the range of from 1 m²/g to 100 m²g. The surface area of the catalyst determines its catalytic activity.

Thus, there is an ongoing need for an optimized catalyst system for use in a catalytic pyrolysis of solid biomass material capable of producing liquid reaction products having low oxygen content, while reducing the risk of over-cracking the biomass feedstock and/or the primary reaction products.

### BRIEF SUMMARY OF THE INVENTION

It is an object of the invention to provide a catalyst system for producing or upgrading a biocrude material, said catalyst system comprising an inorganic carbonate (CO₃²⁻) or hydrogencarbonate HCO₃⁻) on a substantially inert support material.

Another aspect of the invention comprises a method for contacting biomass material with the catalyst system, and a method for preparing the catalyst system.

### DETAILED DESCRIPTION OF THE INVENTION

The following is a detailed description of the invention.

### Definitions

The term “biomass material” as used herein means any solid biologically produced renewable material, in particular plant-based solid material, and more particularly plant material comprising ligno-cellulose.

The term “biocrude” as used herein means the liquid reaction product resulting from the pyrolysis of a solid biomass material. If the pyrolysis reaction produces, in its liquid reaction product, a water-rich phase and a water-poor phase, the term “biocrude” refers specifically to the water-poor phase.

The term “carbonate” as used herein refers to inorganic salts comprising the CO₃²⁻ anion. The term includes both water-soluble and water-insoluble salts, with the proviso that the solubility of even water-soluble salts is diminished as a result of their being deposited on a support.

The term “hydrogencarbonate” as used herein refers to inorganic salts comprising the HCO₃⁻ anion. Such salts are oftentimes colloquially referred to as “bicarbonates.” The term includes both water-soluble and water-insoluble salts, with the proviso that the solubility of even water-soluble salts is diminished as a result of their being deposited on a support.

The term “substantially inert support material” as used herein means a support material that has no catalytic activity, or has a catalytic activity that is much lower than that of the carbonate or bicarbonate material present on the support. The support material may be inherently inert, or it may have become inert as a result of a pre-treatment resulting in a reduction of the specific surface area of the support material. Examples of such pretreatment include calcination in an inert gas atmosphere or under vacuum; calcination in an oxygen-containing atmosphere; calcination in a steam atmosphere; and the like. The skilled person will be familiar with pretreatment processes that are known to “destroy” the catalytic properties of such materials. A special example of a pretreatment that makes a material suitable for use as inert support material in the catalyst system of the present invention is its prolonged use as a catalyst in an unrelated reaction. In other words, used catalysts from, for example, the refinery industry, can be used as support materials in the catalyst systems of the present invention. This use of abundantly available waste materials from other industries is a particularly attractive aspect of the present invention.

The pyrolysis of biomass material can be carried out thermally, that is, in the absence of a catalyst. An example of a thermal pyrolysis process that may be almost as old as mankind is the conversion of wood to charcoal. It should be kept in mind that solid biomass materials in their native form invariably contain at least some amount of minerals, or “ash”. It is generally recognized that certain components of the ash may have catalytic activity during the “thermal” pyrolysis process. Nevertheless, a pyrolysis process is considered thermal if no catalysts are added.

The charcoal making process involves slow heating, and produces gaseous products and solid products, the latter being the charcoal. Pyrolysis processes can be modified so as to produce less char and coke, and more liquid products. In general, increasing the liquid yield of a biomass pyrolysis process requires a fast heating rate; a short reaction time; and a rapid quench of the liquid reaction products.

Fluidized bed reactors and transport reactors have been proposed for biomass pyrolysis processes, as these reactor types are known for the fast heating rates that they provide. In general, heat is provided by injecting a hot particulate heat transfer medium into the reactor.

U.S. Pat. No. 4,153,514 discloses a pyrolysis reactor in which char particles are used as the heat transfer medium.

U.S. Pat. No. 5,961,786 discloses a transport reactor type pyrolysis reactor, using sand as the heat transfer medium. Although the patent mentions the possibility of using mixtures of sand and catalyst particles or silica-alumina as the heat transfer medium, all examples in the patent are based on experiments in which sand was used as the sole heat transfer medium. According to data in the '786 patent, the use of sand produces better results than when char is used as the heat transfer medium.

The liquid product made by the process of the '786 patent is a liquid smoke flavoring product, intended to be used for imparting a smoke or BBQ flavor to food products, in particular meats. The liquid products are characterized by a low pH (around 3), and a high oxygen content. The patent specifically mentions the propensity of the liquid to develop a brown color, a property which is apparently desirable for smoke flavoring products. All three characteristics (low pH, high oxygen content, brown, and changing, color) are highly undesirable in liquid pyrolysis products intended to be used as, or upgraded to, liquid fuels. Because of the low pH these liquid products cannot be processed in standard steel, or even stainless steel, equipment. Their corrosive character would require processing in glass or special alloys.

Due to the high oxygen content, upgrading of these liquids to produce an acceptable liquid fuel, or an acceptable blending stock for a liquid fuel, would require extensive hydrotreatment in expensive equipment, able to withstand the high pressures involved in such processes. The hydrotreatment would consume large amounts of expensive hydrogen.

WO 2009/118363 A2 teaches a process for the catalytic pyrolysis of biomass material using a solid base as catalyst. The solid particulate biomass material was pre-treated with a different catalyst. The resulting liquid pyrolysis product had low oxygen content, as evidenced by a low Total Acid Number (TAN). Best results were obtained with Na₂CO₃ or K₂CO₃ as the pretreatment catalyst, and hydrotalcite (HTC) as the solid base catalyst.

Although the results reported in WO 2009/118363 A2 have been confirmed in larger scale reactors, the use of two different catalysts, which are added at two different stages of the process, poses an inherent problem. Inevitably, the two catalyst materials become mixed with each other in the reactor. For a continuous process the two catalyst systems would have to be separated, so that one can be recycled to the pretreatment step, and the other to the pyrolysis reactor.

It has also been found that the proposed catalyst system tends to produce a coke yield that is higher than is necessary for providing the required heat to the process. Any coke beyond what is needed for the process is a loss of valuable carbon from the feedstock. It is important to minimize the coke yield as much as possible.

WO 2010/124069 A2 discloses a pyrolysis process in which a catalyst is used that is an oxide, silicate or carbonate of a metal or metalloid, having a specific surface area in the range of from 1 m²/g to 100 m²g. The surface area of the catalyst determines its catalytic activity. Examples include materials such as zeolite ZSM-5.

Williams and Home, Journal of Analytical and Applied Physics 31 (1995) 39-61, report on experiments aimed at upgrading the liquid reaction products of a biomass pyrolysis reaction. ZSM-5 gave the best results.

Catalytic materials like ZSM-5 have strong acidic properties. It has been found that acidic catalysts favor the formation of gaseous by-products, at the expense of the liquid yield. It has further been found that acidic catalysts tend to favor the formation of H₂O over CO and CO₂, and the formation of CO over the formation of CO₂.It will be understood that the formation of all three gaseous byproducts (H₂O, CO, and CO₂) results in a reduction of the oxygen content of the biocrude, which is in and of itself desirable. However, the formation of water does so at the expense of the hydrogen content of the biocrude, which results in the formation of aromatic compounds. Aromatic compounds, although known for their high octane number, are disfavored in modern gasoline blends, because of their high toxicity and carcinogenic properties. Moreover, poly-aromatics are precursors for coke formation, which may lead to further loss of liquid yield. For these reasons the formation of CO and CO₂ as a path to reduced oxygen levels in the biocrude is preferred over the formation of water.

Between CO and CO₂, CO₂ is the more preferred gaseous by-product, as it removes two atoms of oxygen for every carbon atom that is lost, while in the case of CO this ratio is only 1:1.

Thus, there is a need to an optimized catalyst system that can be used in the pyrolysis of solid biomass material or in an upgrading reaction of biocrude that results in a high liquid yield, low oxygen content, relatively low gas formation, and relatively low coke yield.

In its broadest aspect the present invention relates to a catalyst system for producing or upgrading a biocrude material, said catalyst system comprising an inorganic carbonate (CO₃²⁻) or hydrogencarbonate HCO₃⁻) on a substantially inert support material. The inorganic carbonate and hydrogencarbonate materials will be jointly referred to as the “carbonate species.”

The support material serves to provide a greater specific surface area than would be possible by using the carbonate species by themselves, and to reduce the water-solubility of the carbonate species.

Minerals mined from the Earth's crust may be suitable for use as inert support materials in the catalytic system of the invention. Examples include rutile, magnesia, sillimanite, andalusite, pumice, mullite, feldspar, fluorspar, bauxite, barites, chromite, zircon, magnesite, nepheline, syenite, olivine, wollasonite, manganese ore, ilmenite, pyrophylite, perlite, slate, anhydrite, and the like. Such minerals are rarely encountered in a pure form, and do generally not need to be purified for the purpose of being used in the catalyst system of the present invention. Many of these materials are available at low cost, some of them literally deserving the moniker “dirt cheap”.

Generally, minerals as-mined are not suitable for direct use as support materials in the catalytic system; such materials are referred to herein as “support material precursors”, meaning that they can be converted to support materials for the catalyst system by some kind of pretreatment. Pretreatment may include drying, extraction, washing, calcining, or a combination thereof.

Calcining is a preferred mode of pretreatment in this context. It generally involves heating of the material, for a short period of time (flash calcination) or for several hours or even days. It may be carried out in air, or in a special atmosphere, such as steam, nitrogen, or a noble gas.

The purpose of calcining may be various. Calcining is often used to remove water of hydration from the material being calcined, which creates a pore structure. Preferably, such calcination is carried out at a temperature of at least 400° C. Mild calcination may result in a material that is rehydratable. It may be desirable to convert the material to a form that is non-rehydratable, which may require calcination at a temperature of at least 600° C.

Calcination at very high temperatures may result in chemical and/or morphological modification of the material being calcined. For example, carbonates may be converted to oxides, and mixed metal oxides may be converted to a spinel phase. In general, catalyst manufacturers try to avoid such modifications, as they are associated with a loss of catalytic activity. For the purpose of the present invention, however, such phase modification may be desirable, as it can result in a support material having the desired inert characteristics.

Calcination processes aiming at chemical and/or morphological modification generally require high calcination temperatures, for example at least 800° C., or even at least 1000° C.

Examples of calcined materials suitable for use on the catalytic system of the invention include calcined coleminite, calcined fosterite, calcined dolomite, and calcined lime.

Calcination may also be used to passivate contaminants having an undesired catalytic activity. For example, bauxite, consisting predominantly of aluminum oxides, is an abundantly available material having a desirable catalytic activity profile. However, iron oxides, which are generally present in bauxite, may undesirably raise the catalytic activity of bauxite. Calcination at high temperature, for example at least 800° C. passivates the iron oxides so as to make the material suitable for use as support material in the catalytic system, without requiring the iron oxides to be removed in an expensive separation step.

From this perspective, so-called “red mud” is an interesting material. It is a by-product of bauxite treatment in the so-called Bayer process, whereby the aluminum oxides are dissolved in caustic (NaOH) to form sodium aluminate. The insoluble iron oxides, which are brownish-red in color, are separated from the aluminate solution. This red mud is a troublesome waste stream in the aluminum smelting industry, requiring costly neutralization treatment (to get rid of the entrapped caustic) before it can be disposed of in landfill. As a result, red mud has a negative economic value. Upon calcination, however, red mud can be used as support material in the catalytic system of the invention. Its alkaline properties are desirable, as it captures the more acidic (and more corrosive) components of the pyrolysis reaction product.

Steam deactivation can be seen as a special type of calcination. The presence of water molecules in the atmosphere during steam deactivation mobilizes the constituent atoms of the solid material being calcined, which aids its conversion to thermodynamically more stable forms. This conversion may comprise a collapse of the pore structure (resulting in a loss of specific surface area), a change in the surface composition of the solid material, or both. Steam deactivation is generally carried out at temperatures of at least 600° C., sometimes at temperatures that are much higher, such as 900 or 1000° C.

Phyllosilicate minerals, in particular clays, form a particularly attractive class of catalyst precursor materials. These materials have layered structures, with water molecules bound between the layers. They can readily be converted to catalyst systems of the invention, or components of such systems.

The general process will be illustrated with reference to kaolin clay. The process can be used for any phyllosilicate material, in particular other clays, such as bentonite or smectite clays. The term “kaolin clay” generally refers to clays, the predominant mineral constituent of which is kaolinite, halloysite, nacrite, dickite, anauxite, and mixtures thereof.

In the process, powdered hydrated clay is dispersed in water, preferably in the presence of a deflocculating agent. Examples of suitable deflocculating agents include sodium silicate and the sodium salts of condensed phosphates, such as tetrasodium pyrophosphate. The presence of a deflocculating agent permits the preparation of slurries having higher clay content. For example, slurries that do not contain a deflocculating agent generally contain not more than 40 to 50 wt % clay solids. The deflocculating agent makes it possible to increase the solid level to 55 to 60 wt %.

The aqueous clay slurry is dried in a spray drier to form microspheres. For use in fluidized bed or transport reactors, microspheres having a diameter in the range of from 20 μm to 150 μm are preferred. The spray dryer is preferably operated with drying conditions such that free moisture is removed from the slurry without removing water of hydration from the raw clay ingredient. For example, a co-current spray drier may be operated with an air inlet temperature of about 650° C. and clay feed flow rate sufficient to produce an outlet temperature in the range of from 120 to 315° C. However, if desired the spray drying process may be operated under more stringent conditions so as to cause partial or complete dehydration of the raw clay material.

The spray dried particles may be fractionated to select the desired particle size range. Off-size particles may be recycled to the slurrying step of the process, if necessary after grinding. It will be appreciated that the clay is more readily recycled to the slurry if the raw clay is not significantly dehydrated during the drying step.

The microsphere particles are calcined at a temperature in the range of from 850 to 1200° C., for a time long enough for the clay to pass through its exotherm. Whether a kaolin clay has passed through its exotherm can be readily determined by differential thermal analysis (DTA), using the technique described in Ralph E. Grim's “Clay Mineralogy”, published by McGraw Hill (1952).

Calcination at lower temperatures converts hydrated kaolin to metakaolin, which generally has too high a catalytic activity for use as support material in the catalytic system of the invention. However, calcination conditions resulting in a partial conversion to metakaolin, the remainder being calcined through the exotherm, may result in suitable support materials for the catalytic system of this invention.

Materials as obtained by the above-described process are commercially available as reactants for the preparation of zeolite microspheres. For the purpose of the present invention, the materials are used as obtained from the calcination process, without further conversion to zeolite. The calcined clay microspheres typically have a specific surface area below about 15 m²/g.

If desired the slurry may be provided with a small amount of a combustible organic binder, such as PVA or PVP, to increase the green strength to the spray dried particles. The binder is burned off during the calcination step.

Processes similar to the one described herein for the conversion of kaolin clay can be used for producing microspheres from other catalyst precursors. Examples of suitable catalyst precursors include hydrotalcite and hydrotalcite-like materials; aluminosilicates, in particular zeolites such as zeolite Y and ZSM-5; alumina; silica; and mixed metal oxides. The process generally comprises the steps of (i) preparing an aqueous slurry of the precursor; (ii) spray drying the slurry to prepare microspheres; (iii) calcining the microspheres to produce the desired specific surface area. In this context it should be kept in mind that the term calcining as used herein encompasses steam deactivation. For highly active materials, such as zeolites, steam deactivation may be the preferred calcination process.

As mentioned earlier, particularly attractive support materials are catalysts that have become deactivated in the course of their use. For use as support materials in the catalyst system of the present invention additional deactivation pretreatment may be necessary.

Particularly suitable also are catalyst support materials, such as silica, activated coal, and TiO₂, that are inherently devoid of catalytic properties.

In general the support material is pretreatment so as to have a specific surface area in the range of 1 m²/g to 100 m²/g. Support materials that are inherently devoid of catalytic activity may be used at specific surfaces at the high end of this range, or even exceeding 100 m²/g. For materials that inherently have catalytic activity, pretreatment aimed at reducing the catalytic activity generally include a reduction of the specific surface area. Materials of this kind are generally used with a specific surface area in the range of from 1 to 50 m²/g, more typically from 5 to 30 m²/g.

Any inorganic carbonate species may be used as the active component of the catalyst system. Specific examples include the carbonates and hydrogen carbonates of alkali metals and alkaline earth metals. Carbonate species of other metals may be used, but it will be understood that such other metals may be more costly, without adding to the desired properties of the catalyst system. Preferred carbonate species are the carbonates and hydrogencarbonates of Na and K, those of K being particularly preferred.

The carbonate species may be deposited onto the support material by any method known in the art. For example, the support material may be impregnated with an aqueous solution of the carbonate species; dried; and calcined. Care should be taken to avoid conversion of the carbonate to, for example, the corresponding oxide during calcination. In addition, certain carbonate species can be readily converted from the carbonate form to the hydrogencarbonate form, and v.v. It has been found that this property is highly desirable for the catalyst system. Calcination may result in conversion into a carbonate species that no longer readily converts into the corresponding hydrogencarbonate species; such conversion should be avoided. In general, calcination should be carried out under mild conditions, such as a temperature of 400° C. or below, and an inert or reducing atmosphere.

The carbonate load on the support may be in the range of from 0.5 to 20 wt %, more typically in the range of from 5 to 10 wt %.

The catalyst system of the invention can be used as the catalyst in a catalytic pyrolysis of a solid biomass; in the catalytic upgrading of a biocrude, or both.

The solid biomass material for use in the pyrolysis reaction preferably is of plant origin, in particular solid biomass containing cellulose or ligno-cellulose. Examples include wood, straw, bagasse, switch grass, and the like.

The catalytic pyrolysis reaction comprises contacting the solid biomass material with the catalyst system of the invention at a temperature in the range of from 200° C. to 600° C., preferably in the range of from 300° C. to 450° C. The reaction can be carried out, for example, in a fluid bed reactor.

The pyrolysis reaction produces, in addition to coke and gaseous reaction product, a liquid reaction product. In general, the catalyst system produces a liquid reaction product that is sufficiently low in oxygen content that the liquid reaction products spontaneously split into an organic phase and a water-rich phase. The organic phase is referred to as biocrude. It is of sufficient quality to be processed in a conventional oil refinery, either by itself or in admixture with a fossil oil product stream.

The effectiveness of the catalyst system may be improved by intimately mixing the solid biomass material with the catalyst system, prior to the pyrolysis reaction, using mechanical action. Examples of suitable mechanical action include milling, grinding, co-extruding, and the like.

In an alternate embodiment the solid biomass is intimately mixed with a carbonate species by mechanical action, such as milling, grinding, co-extrusion, etc. The pretreated biomass is pyrolytically converted in a fluid bed reactor, wherein the inert support material is used as the heat carrier. The solid materials are separated from the reaction products before condensation of the reaction products takes place. The carbonate species settle onto the inert support material, so that the catalyst system is, in fact, formed in the pyrolysis reactor.

If a fluid bed reactor is used for the pyrolysis reaction, the catalyst system can be readily separated from the product streams, using standard techniques, such as cyclones. Coke formed during the pyrolysis reaction is generally deposited on the catalyst system, as a result of which the catalyst system has become deactivated. The catalyst can be reactivated by burning off the coke, similar to the catalyst reactivation process as used in a process known from the oil refinery industry as the Fluid Catalytic Cracking (FCC) process. Heat formed in the deactivation process raises the temperature of the catalyst. The heated catalyst carries the heat energy to the fluid bed reactor (the “riser”, in FCC terminology), where it feeds the endothermic pyrolysis reaction.

It is desirable to run an incomplete reactivation of the catalyst, so that a small amount of coke remains on the catalyst. This residual coke provides a reductive environment, thereby preventing a conversion of the carbonate species to the corresponding oxide. In the riser the residual coke provides a reductive atmosphere as well, which improves the quality of the biocrude.

Another aspect of the invention is the use of the catalyst system in an upgrading reaction of a biocrude. Such upgrading reaction may be carried out in a fluid bed reactor, for example as described by Williams and Home, Journal of Analytical and Applied Physics 31 (1995) 39-61.

Many modifications in addition to those described above may be made to the structures and techniques described herein without departing from the spirit and scope of the invention. Accordingly, although specific embodiments have been described, these are examples only and are not limiting upon the scope of the invention.

Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A catalyst system for producing or upgrading a biocrude material, said catalyst system comprising carbonate species, comprising an inorganic carbonate (CO₃²⁻) and/or hydrogencarbonate HCO₃⁻), on a substantially inert support material.

2. The catalyst system of claim 1 which is formed by impregnating the substantially inert support material with a solution of the carbonate species.

3. The catalyst system of claim 1 which is formed by (i) intimately contacting a solid biomass material with the carbonate species; (ii) subjecting the biomass material to pyrolysis in the presence of the substantially inert support material; (iii) allowing the carbonate species to settle onto the substantially inert support material.

4. The catalyst system of claim 1 for use in a catalytic pyrolysis process.

5. The catalyst system of claim 4 for use in the catalytic pyrolysis of a lignocellulosic biomass material.

6. The catalyst system of claim 1, comprising a hydrogencarbonate and/or a carbonate capable of forming a hydrogencarbonate.

7. The catalyst system of claim 1, wherein the support material has a specific surface area in the range of from 1 m²/g to 100 m²/g, preferably in the range of from 10 m²/g to 30 m²g.

8. The catalyst system of claim 7, wherein the support material is selected from the group of titania, activated coal, calcined alumina, calcined silica, calcined clay, collapsed zeolite, and mixtures thereof.

9. The catalytic pyrolysis process comprising the step of contacting a biomass material with the catalyst system of claim 1, at a temperature in the range of from 200° C. to 600° C., preferably in the range of from 300° C. to 450° C.

10. The process of claim 9, wherein the step of contacting a biomass material with the catalyst system is carried out in a fluid bed reactor.

11. The process for upgrading a pyrolysis oil comprising the step of contacting the pyrolysis oil with the catalyst system of claim 1, at a temperature in the range of from 200° C. to 450° C.

12. The biocrude produced in the process of claim 9.
